(19) United States
(12) Patent Application Publication
(10) Pub. No.: US 2012/0265443 A1
(43) Pub. Date: Oct. 18, 2012

(54) METHOD OF LOGGING A BOREHOLE AND RELATED APPARATUS

(75) Inventor: James Roger Samworth, Leicestershire (GB)

(73) Assignee: Reeves Wireline Technologies Limited, Leicestershire (GB)

(21) Appl. No.: 13/371,108

(22) Filed: Feb. 10, 2012

(30) Foreign Application Priority Data
Feb. 15, 2011 (GB) 1102613.5

(51) Int. Cl. G01V 5/10; G06F 19/00

(52) U.S. Cl. 702/8

(57) ABSTRACT

In a method of logging a geological formation, a neutron generator is pulsed to generate a series of neutron bursts that irradiate the formation. Mutually spaced radiation detectors are operated without counting or detecting individual pulses stimulated by a burst from the neutron generator. The detectors are located to detect neutrons that have traversed the formation and to generate respective current outputs indicative of the neutron detection at the respective detectors. The current outputs of the detectors are integrated to generate respective analog waveforms characteristic of the count rates at the detectors. Each of the analog waveforms is converted to digital form, and the respective digital waveforms are compared to establish a ratio of radiation detector count rates corresponding to the outputs of the respective radiation detectors. From the resulting ratio, a compensated measure of the neutron-based porosity of the formation is established.

### CROSS-REFERENCE TO RELATED APPLICATIONS

This application claims the benefit under 35 U.S.C. 119(a) to UK Pat. Appl. No. GB1102613.5, filed 15 Feb. 2011.

### FIELD OF THE DISCLOSURE

This invention relates to a method of logging a borehole and related apparatus.

### BACKGROUND OF THE DISCLOSURE

It is known in the oil and gas industries to log characteristics of a geological formation using a neutron source forming part of a logging tool. Irradiation of a formation with high energy neutrons results in a phenomenon known as neutron capture, in which the neutrons react with atomic nuclei (that typically but not necessarily are hydrogen nuclei) in the formation in a per se known reaction.

This reaction generates gamma radiation that is detectable in a borehole formed in the formation in a way that may provide information about the likelihood of the formation containing hydrocarbons the extraction of which on an economic basis is strongly desired.

The reaction eliminates the neutrons that have collided with nuclei that cause capture. Not all the neutrons emitted from the source into the formation however undergo capture, and some of them return to the vicinity of the logging tool having passed through the rock of the formation without encountering hydrogen (or other nuclei that give rise to capture). By assessing the number of neutrons returning to the tool (or another location that involves passage of the returning neutrons through the rock) it is possible to obtain a measure of the porosity of the formation.

The explanation for this is that the neutrons which pass through pores in the rock are likely to react with chemicals containing hydrogen ions (i.e. water, hydrocarbons or mixtures thereof) and undergo capture whereas the neutrons passing through the rock are essentially unchanged (apart from changes in their energy levels) by their passage.

The count of returned neutrons is inversely proportional to the amount of hydrogen present in the formation and hence provides an indication of apparent formation porosity. Measuring the quantity of neutrons returning to the vicinity of the source in other words contributes to assessing the quantity of hydrocarbon material present. Measurements made in this way therefore are extremely important to oil and gas companies.

Broadly speaking, two types of detector are known to be used in neutron logging tools:
gamma radiation detectors employed in techniques involving assessments of neutron capture or the rate of neutron radiation decay in order to obtain a measure of porosity or of sigma, the neutron capture cross-section; and
neutron radiation counters that count the numbers of neutrons returning to the logging tool after passage through the rock without capture occurring and therefore give an indication of porosity.

Traditionally neutron logging has involved the use of a continuous neutron source (i.e. a neutron-generating isotope within a container) forming part of the logging tool. In conventional logging tools the source emits neutrons by reason of (uninterrupted) radioactive decay of the source material.

In recent years there has however been a tendency for oil and gas companies to discourage the use of isotopic neutron sources in their boreholes.

This is partly because of legal, insurance and practical problems that arise for example when ultimately disposing of the neutron sources at the ends of their service lives. Moreover the radioactive source materials employed have in recent years in any event become hard to obtain; and transporting them has been the subject of increasingly restrictive regulation.

Also, if a logging tool containing a continuous neutron source becomes lost or irretrievably struck in a downhole location, it is necessary to entomb the source in the borehole.

This is achieved by pumping concrete into the borehole. Subsequent to the entombing operation it is necessary to drill a new borehole. These activities are very expensive and time-consuming.

It has therefore been proposed to use, in place of a continuous neutron source, a neutron generator tube. One form of such a device employs a vacuum tube containing Deuterium and Tritium gas to generate neutrons. The neutron generator tube operates by using an ion source at one end of the tube to generate Deuterium and Tritium ions. These are extracted from the ion source in bursts and accelerated by a high voltage potential, of the order 100,000 volts, on an arrangement of cathodes and anodes towards Deuterium and Tritium ions embedded in a target at the other end of the tube. The known deuterium-tritium (d-t) reaction then generates neutrons that are emitted from the target.

The use of the neutron generator tubes in the logging of subterranean formations surrounding boreholes is in principle preferable to the use of continuous, isotopic sources for the reasons set out above. Nonetheless there are further disadvantages associated with the use of the neutron generator tubes.

In order to generate a high number of neutron bursts efficiently, it is necessary to employ a continuously operating DC voltage generator comprising an array of diodes. This is necessary to cause the 100,000 volt gradient required to accelerate the deuterium and tritium ions and so generate neutrons.

The DC voltage generator is comparatively long. This makes it potentially unsuitable for incorporation into a logging tool intended to pass along a borehole, which may not be straight or parallel-sided.

Voltage gradients of less than 100,000 volts are inefficient, generating few neutrons in the generator tube.

It is however theoretically possible in the alternative to employ a relatively low burst rate neutron generator that uses a pulsed voltage on the target instead of continuous, direct current. The low burst rate generator does not require the DC generator described above and instead employs a (much shorter, cheaper and simpler) voltage induction coil arrangement.

Pulsed neutron logging therefore is a technique that employs a pulsed form of neutron generator which is periodically actuated to produce multiple short bursts of neutrons and is quiescent between groups of bursts.

The use of a low burst rate neutron generator however has not proved successful. This is mainly because many neutrons are generated in the short period of time of the burst. As a result the detector pulses are equally closely spaced in time, causing problems as discussed below.

FIG. 1 illustrates the typical pattern of neutron bursts from a low burst rate neutron generator. As is represented in FIG. 1, a neutron burst 10 causes a series of (voltage) pulses 11 in the detector, the temporal spacings of the pulses lengthening with time after each generator burst.

Since the neutrons are emitted in bursts so are the detector pulses, causing pulse pile up, difficulty in resolving individual pulses and considerable problems in detector dead time correction if it is required to count the pulses individually as has been attempted in the prior art. Dead time causes non-linearity that can be illustrated with the following example:

Example of Neutron Detector Problems

Suppose the logging tool includes two neutron detectors with, say, 10 microseconds dead time (which to practical purposes in the current illustration is equivalent to resolving time), and it is desired to compute a detector count rate ratio as is normally done with compensated neutron porosity logging. By “count rate ratio” is meant the ratio of neutron count rates between two mutually spaced neutron detectors located in the tool.

Suppose neutrons giving rise to true count rates of 20000 and 2000 (count rate ratio=10) are incident on the respective detectors of the pair.

Dead time however is related to the apparent count rate by the formula:

$$Apparent count rate = \frac{True count rate}{( 1 + ( True count rate ) * ( Dead time ) )}$$

After dead time takes its effect therefore these true rates appear as 16667 and 1961 in the respective detector outputs (i.e. a count rate ratio of 8.50).

The principle of neutron porosity logging uses the count rate ratio as this reduces the effect of perturbations, especially those produced by the wellbore fluid. Salt in this fluid (i.e. the chlorine) removes neutrons but does not affect the ratio very significantly.

If salt is added to the wellbore fluid in the above example, the true count rates may fall to 10000 and 1000 respectively (which still gives rise to a true ratio of 10).

After dead time again has an effect these true rates appear as 9091 and 990 respectively (i.e. a count rate ratio of 9.18, which is quite different to the original 8.50, and also different to the true ratio (10)). The resulting inaccuracies are unacceptable in logging operations.

It is possible correct for the dead time, but the correction becomes imprecise when the dead time and the average time between pulses are of the same order.

If the dead time is above 10%, it is accepted that the correction becomes unreliable—with dead times of 10 microseconds this occurs at a count rate of 10000/second (10000*10 microseconds=0.1 per second=10%). The situation becomes even more problematic if the neutrons arrive in bursts, as the instantaneous count rate during or near the burst can be very high indeed. A technique that avoids the dead time problem altogether would therefore be very beneficial.

A way of reducing the effects of dead time would be to distribute the neutron emission over more bursts. Even when relatively few neutrons are produced in large numbers of temporally adjacent bursts however significant problems may still arise. For example as the logging progresses the neutrons cause the logging tool and its contents to become slightly and temporarily radioactive, resulting in an increase in the background radiation seen by the detector (if gamma detection is being employed). This has to be subtracted from the measured signal for correct processing of the decaying detector count rates when this is the detection mode adopted.

With generators operating at the high frequencies indicated, the sequence of pulses has to be periodically halted to let the signal decay die away sufficiently for this background to be measured. This is often complex to achieve accurately in a logging tool.

When the emission of the neutrons takes place over many bursts, typically 1000 bursts occur per second. When using the low burst rate generators mentioned the bursts occur at a rate of perhaps 20 per second and any dead time and resolution problems remain significant.

It therefore would be desirable to eliminate the pulse pile-up, resolution, detector dead time, and background radiation build-up of the prior art.

When considering the use of neutron logging techniques in order to measure radiation decay, the radiation intensity is measured using a detector in at least one preselected time interval. By intercomparing measurements in discrete time intervals the rate of neutron die-away can be determined. There exist several mathematical approaches to analyzing the count rates so as to generate accurate indications of the rate of neutron die-away. Some of these techniques rely on the measurement of radiation intensity in two or more time intervals.

In any event, as stated, the measured die-away rate has been shown both by theory and experiment to be a measure of the thermal neutron capture cross section of the medium (i.e. the materials in the formation) in which the neutrons are captured. The thermal neutron capture cross-section per unit of volume of formation material is referred to as Σ. It is related to L, termed the lifetime of neutrons in a material, by the equation:

$$\sum = \frac{3.15}{L}$$

Thermal neutrons are captured mainly by the chlorine present. Hence the tool responds to the amount of salt in the formation water. Hydrocarbons result in longer lifetimes than salt water. A logging tool that utilizes the above-outlined pulsed neutron decay principles can be used in cased holes where resistivity logs cannot be run or to monitor reservoir changes to optimize production. The log produced resembles a per se known resistivity log with which it is generally correlatable.

### SUMMARY OF THE DISCLOSURE

The invention is applicable both to situations in which the radiation detector consists of a pair of neutron counters; and those in which the detector is of a type that measures radiation die-away as outlined. Indeed, the invention is successful in respect of a range of source and detector types.

According to the invention in a broad aspect there is provided a method of logging a geological formation, comprising the steps of:
(i) pulsing a neutron generator so as to generate a series of neutron bursts that irradiate the formation;
(ii) without counting or detecting individual pulses stimulated by a burst from the neutron generator, operating a pair of mutually spaced radiation detectors that are located so as to detect neutrons that have traversed the formation and generate respective current outputs that are indicative of the neutron detection at the respective detectors;
(iii) integrating the current outputs of the radiation detectors to generate respective analog waveforms that are characteristic of the count rates at the detectors;
(iv) converting each of the analog waveforms to digital form;
(v) comparing the respective, resulting digital waveforms in order to establish a ratio of radiation detector count rates corresponding to the outputs of the respective radiation detectors; and
(vi) from the resulting ratio, establishing a compensated measure of the neutron-based porosity of the formation.

As is explained in more detail below, advantages of this method include the complete elimination of inaccuracies caused either by detector dead time or by inadequate detector resolution. This is because no attempt is made to count individual pulses. Instead the detector outputs are integrated over a sampling period and the integrated value used for subsequent calculation and processing.

This in turn means that a true ratio of count rates as seen by each of the detectors of the pair is preserved, regardless of the resolution and dead time characteristics.

At the same time the method is suitable for use with sources of any of the three types mentioned (i.e. the continuously operating DC neutron generator tube and the pulsed, relatively high and relatively low burst rate generators).

To this end, preferably, the generator is selected from the list comprising:
a continuously operable DC neutron generator tube;
a pulsed neutron generator tube arranged to operate at a relatively high burst rate; and
a pulsed neutron generator tube arranged to operate at a relatively low burst rate.

A relatively high burst rate generator produces about 1000 bursts per second; and a relatively low burst rate generator about 20 bursts per second. In the case of relatively low burst rate generators the nature of the pulse waveform dictates that a burst rate of 20 bursts per second is commonly achieved. In theory higher burst rates, up to perhaps 50 per second, may be possible but in reality the efficiency of the device at such a burst rate is poor because of a need for the pulse voltage repeatedly to exceed a threshold and then decline. Therefore when considering relatively low burst rate generators in the context of the invention although the use of generators that operate at burst rates of up to 50 bursts per second is not excluded, preferably the burst rate is approximately 20 bursts per second.

In line with the broad applicability of the method of the invention, in a preferred embodiment each radiation detector of the pair is a neutron counter. In such a case, preferably the neutron counter is a gas-filled detector.

The use of such detectors in the method of the invention conveniently permits the efficient calculation of apparent porosity in line with techniques outlined above.

A further problem that can arise is with the outputs of the analog-to-digital converters. A voltage offset may exist in the analog-to-digital conversion circuitry and it is necessary to compensate for this when processing the outputs of the neutron counters.

When a low burst rate pulsed generator is employed it becomes possible to measure the background radiation or the analog-to-digital offset (as appropriate, depending on the type of detector employed) every burst, without needing to switch off the generator.

Preferably, therefore, the method includes the step of periodically measuring and compensating for the effects of analog-to-digital voltage offset without interrupting pulsing of the source. Optionally such measuring takes place following each neutron burst, after the neutrons have died away and immediately prior to the next succeeding burst.

A gas-filled neutron detector usually includes a column filled with gaseous He-3 ions, or a mixture formed predominantly of such ions with another substance. In recent years however it has become increasingly difficult to obtain gas-filled He-3 detectors and this is one reason it may be desirable in the method of the invention to employ gamma ray detectors that measure the local neutron population in the vicinity of the detectors by measuring the gamma rays emitted as the neutrons are captured.

To this end, therefore, the method in the alternative may include a pair of gamma detectors as the members of the pair of radiation detectors.

Preferably, the method includes the step of periodically measuring and compensating for the effects of background radiation as would affect the readings of a gamma detector, without interrupting pulsing of the source. Optionally such measuring takes place following each neutron burst, after the neutrons have died away and immediately prior to the next succeeding burst.

An advantage of this aspect of the method relates to unwanted activation of gamma detectors by continuous neutron sources. The use of sources that may be switched off periodically advantageously alleviates this problem.

Regardless of the precise detector type employed to constitute the said pair, optionally the method may include the further step of operating a gamma radiation detector in order to assess the rate of radiation decay following one or more said bursts and determining therefrom an indication of the neutron capture cross-section of the formation.

According to a second aspect of the invention there is provided a logging apparatus for logging a formation, comprising:
(i) a neutron generator that is capable of being pulsed so as to generate a series of neutron bursts that irradiate the formation;
(ii) a pair of mutually spaced radiation detectors that are located so as to detect neutrons that have traversed the formation, following irradiation of the formation by at least one said neutron burst, and generate respective current outputs that are indicative of the neutron detection at the respective detectors;
(iii) an integrator for integrating the current outputs of the radiation detectors to generate respective analog waveforms that are characteristic of the count rates at the detectors;
(iv) an analog-to-digital converter for converting each of the analog waveforms to digital form;
(v) a comparator for comparing the respective, resulting digital waveforms in order to establish a ratio of radiation detector count rates corresponding to the outputs of the respective radiation detectors; and
(vi) a processing device for establishing, from the resulting ratio, a compensated measure of the neutron-based porosity of the formation.

Preferably, the aforesaid apparatus is constituted as a logging tool or part of a logging tool. Such a logging tool may be of any of the types mentioned herein, including but not limited to:
a so-called wireline tool having a diameter of at least 2½″ and designed to be conveyed into a borehole on wireline, the nature and purposes of which will be familiar to the worker of skill in the art;
a tool (sometimes called a “slimline” tool) having a diameter less than 2½″: such a tool may be conveyed on wireline or conveyed by another means into a borehole;
a tool having an on-board power source, such as an array of batteries, and a memory such that the tool may record data in a downhole location for subsequent downloading on recovery of the tool to a surface location: such tools typically but not necessarily are autonomous in the sense that it is not necessary to employ wireline for the purpose of conveying the tool, although this is not excluded.

Hybrid tools, that combine characteristics of the tools listed, are also possible within the scope of the invention. A further, optional possibility is for the apparatus to be constituted as one or more subs that on their own do not amount to tools in themselves but that when assembled together or assembled with other subs constitute logging tools.

Yet a further possibility within the scope of the invention is for one or more of the elements of the apparatus to be located at a location remote from the remainder. Thus, for example, the processing device may if desired by located remotely from the borehole in which the data are logged. In particular, the processing device of the apparatus may be located at a surface location in order to avoid having to deploy processor equipment in a borehole. This in turn permits the use of faster and/or more versatile processing devices, in the apparatus of the invention, than can conveniently be conveyed to downhole locations.

Preferably, the neutron generator is selected from the list comprising:
a continuously operable DC neutron generator tube;
a pulsed neutron generator tube arranged to operate at a relatively high burst rate; and
a pulsed neutron generator tube arranged to operate at a relatively low burst rate.

Further preferably, each radiation detector of the pair is a neutron counter. In such a case preferably the neutron counter is a gas-filled detector. Advantages of such arrangements are specified above in connection with the method aspect of the invention.

Alternatively, the apparatus may include a pair of gamma ray detectors as the members of the pair of radiation detectors that measure the local neutron population in the vicinity of the detectors by measuring the gamma rays emitted as the neutrons are captured.

Optionally, the apparatus of the invention includes a gamma radiation detector that is operable in order to assess the rate of radiation decay following one or more said bursts and the processing device is capable of determining therefrom an indication of the neutron capture cross-section of the formation. Such a detector may be included for example in a sub that is releasably connectable to at least part of the remainder of the apparatus constituted as a logging tool. Alternatively the gamma radiation detector may be incorporated into the apparatus, or operatively connected thereto, in any of a range of other ways that would be known or would occur to the worker of skill in the art.

### BRIEF DESCRIPTION OF THE DRAWINGS

There now follows a description of preferred embodiments of the invention, by way of non-limiting example, with reference being made to the accompanying drawings in which:

FIG. 1 is a plot that schematically illustrates the relationship over time between the bursts generated by a neutron generator on the one hand, and the voltage pulses generated in a neutron detector on the other;

FIG. 2 shows in graphical form the nature of two resolved pulses generated in a neutron detector, which are temporally closely spaced. In FIG. 2, the pulse amplitudes are plotted against time and the figure also indicates the threshold voltage amplitude below which the pulses do not trigger counts;

FIG. 3 shows detector pulses that are similar to those of FIG. 2, except that the pulses are too closely spaced in time to be individually resolvable; and

FIG. 4 schematically illustrates apparatus in accordance with the invention.

### DETAILED DESCRIPTION OF THE DISCLOSURE

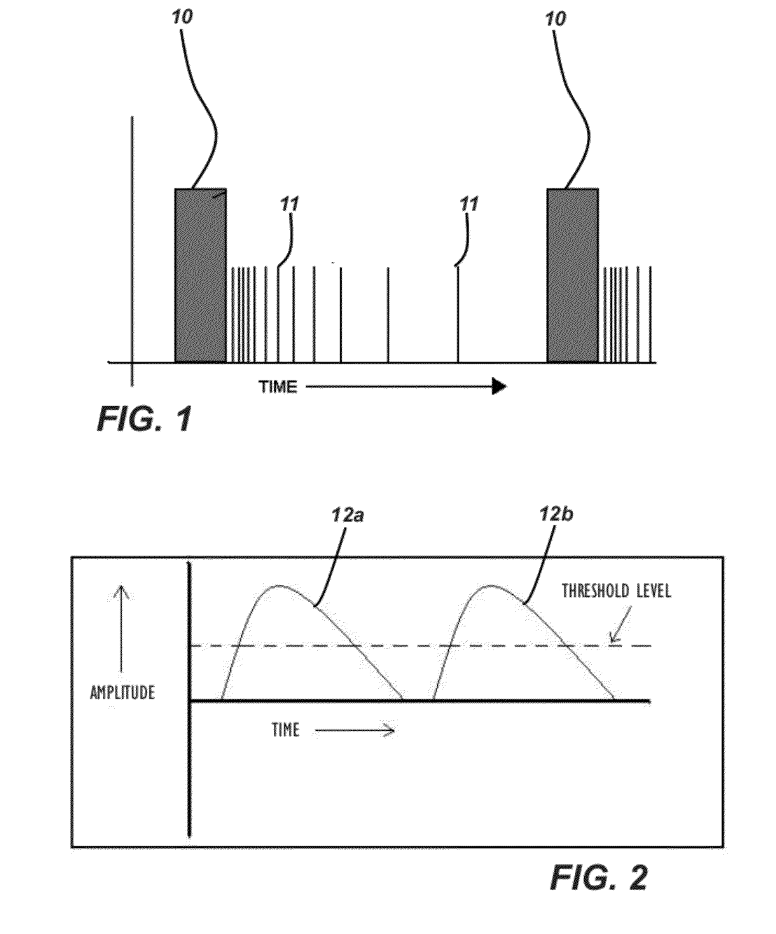

As explained above, FIG. 1 illustrates the relationship between bursts generated in a neutron generator on the one hand, and pulses in a conventional neutron detector arrangement on the other.

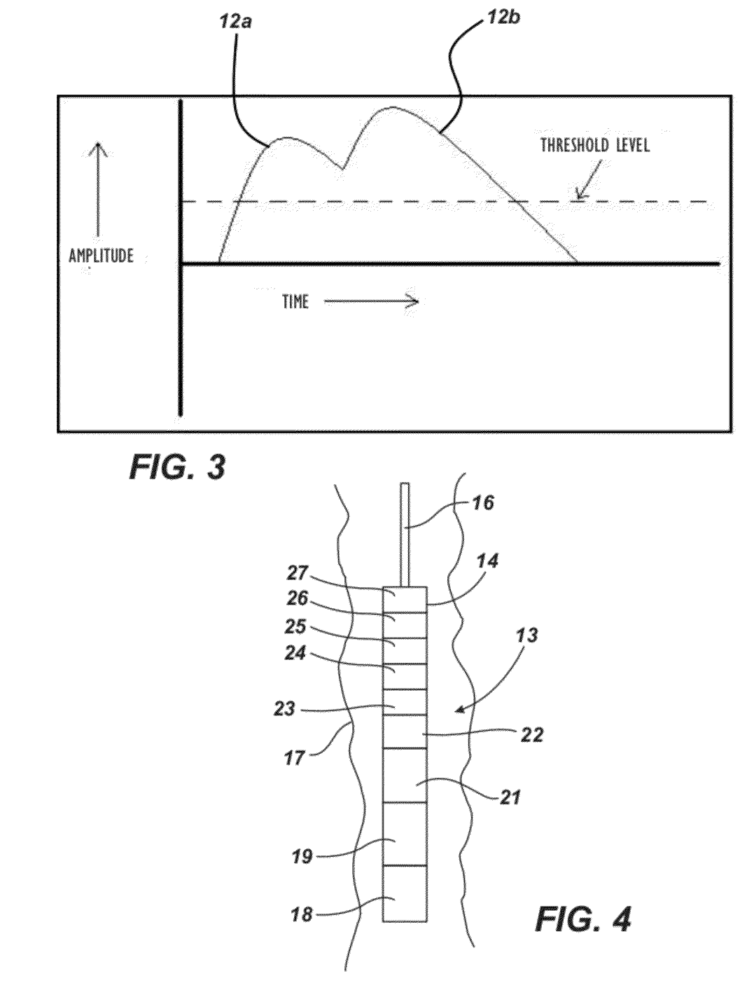

FIGS. 2 and 3 assist in illustrating some of the problems that the method and apparatus of the invention set out to solve. In FIG. 2 two individual detector pulses 12a, 12b are shown occurring one shortly after the other.

In FIG. 2, it is clear that a distinct temporal spacing exists between detection events that derive from pulse amplitudes exceeding the detector threshold. In the FIG. 2 situation therefore it is possible to resolve the two pulses individually.

If the pulses 12a, 12b occur too closely spaced in time, as shown in FIG. 3, it is not possible to identify two distinct pulse events the amplitudes of which exceed the detector threshold. Under such circumstances, as can arise when the neutron generator generates as few as 20 bursts per second, the various problems indicated above can cause any log generated from the pulses to be unacceptably inaccurate. In particular the resolving and dead time issues become problematic because (in the case of the FIG. 3 example) two pulses may generate only a single count 12. When this effect occurs over a significant number of pulse pairs a serious level of inaccuracy can arise.

The method of the invention, however, is based primarily on the imaginative notion that by integrating the detector outputs one may obtain useful data without needing to identify (i.e. count and detect the magnitude of) individual pulses.

In more detail, through integrating the voltage values of the pulses one obtains a measure of the total charge arising at the detector.

In each of FIGS. 2 and 3. the area under the plots above the threshold value is the same (or nearly the same). The integrated detector output therefore indicates the intensity of neutron radiation detected, even if (as in the case of FIG. 3) it is not possible to identify the individual pulses.

In other words, the integration technique of the invention gives the same result in both the FIG. 2 and FIG. 3 situations, and this significantly alleviates the resolution-derived problems discussed because the logging apparatus then becomes able to give a consistent output, regardless of whether resolving of individual pulses is possible.

It is possible to A-D convert the resultant “envelope” visible in FIG. 3 and use this as the signal, as this represents the total charge of the composite pulse. The total charge value may then be processed using a processing device in order to derive a measure of formation porosity, in accordance with the principles set out herein.

A possible problem with this would be the A-D offset varying. However, one may use the fact that the source has discrete bursts to measure the offset immediately prior to the neutron burst, at which time no neutrons will be present. This is akin to a method of measuring the gamma radiation background with a pulsed neutron decay tool. (In the case of neutron detectors, there is no background; it is the A-D offset that is of concern.) At low neutron burst rates (around 20 per second) there is sufficient time for the background or offset to be measured every burst, without switching off the neutron generator.

Another potential problem is that the output of low-cost, low burst rate generators is often not very stable. In the case of their use with the pulsed neutron decay measurement, it is the decay rate that is being measured, and so the actual burst amplitude is not of first-order importance. In the case of a compensated neutron porosity tool one measures the ratio of the signals at two detectors; so again, any variation in source output amplitude would cancel.

The detector integration technique would not work if the nature of the pulses from the detector was dependent on formation properties. This is not the case in this invention as although a spectrum of pulse heights is seen from a neutron-detecting proportional counter (e.g. He-3 or BF₃ types) this is a result of the ionization process following the energy released after the capture of a thermal neutron in the detector, and has no formation property dependence. It is simply related to the detector geometry.

The higher neutron energy of accelerator sources will probably require longer source-detector spacings than are used in isotopic sources, but the resulting lower count rates from this would be offset by their higher output.

As indicated, the method of the invention may include the step of operating one or more gamma detectors in order to detect sigma in addition to porosity. To this end any apparatus used in order to carry out the steps of the method may optionally include a gamma detector that detects gamma decay. The output of such a detector may be processed in the processing device to generate a neutron capture cross-section log. Such apparatus is schematically illustrated in FIG. 4.

This Figure shows a logging apparatus 13 comprising, in the embodiment shown, a series of subs that are connected together in a per se well known fashion to define an elongate, cylindrical logging tool 14.

In other embodiments of the invention, however, the logging apparatus does not need to be constituted as a series of individual subs. One possibility therefore is for the logging tool to possess a single, hollow, cylindrical housing inside which the various parts are located so as to perform their functions.

Tool 14 may be of any of the types described herein. In the illustrated embodiment the tool 14 is shown suspended on wireline 16 in a borehole 17 formed in a rock formation.

The wireline, as is well known, is sufficiently strong as to support the logging tool 14 (that may be several meters long and may weight many tens of kilograms). The wireline 16 also incorporates one or more data and/or power transmission cables. These convey electrical signals from the tool to and from a surface location and also may provide power for operating the various subs of the tool 14.

As explained, however, the presence of wireline is not essential to the success of the operation. The tool 14 may be of a type that does not rely on wireline and instead includes an on-board power supply and a memory for the purpose of logging formation data.

It also is not essential that all parts of the apparatus 13 exist adjacent one another in essentially the same location. Thus, for example, a processing device 26 forming part of the tool 14 described below may, if the tool 14 operates on the basis of a wireline connection, be located e.g. at a surface location that is not close to the point in the log at which the tool acquires data.

In the remainder of this description, however, for convenience the parts of the logging apparatus are assumed to be secured in an assembled tool as shown. The logging tool 14 may be any of a range of diameters as discussed herein.

A sub 18 of the tool 14 shown contains a neutron generator that may be any of the types described herein. The neutron generator is capable of irradiating the rock surrounding the tool 14 with neutron radiation generated in bursts, in accordance with the operational methods described.

Two further subs 19, 21 contain respective radiation detectors. As described, these may be pairs of neutron detectors or pairs of gamma detectors, either of which detector types may usefully be employed to establish count rate ratios indicative of formation rock porosity.

The tool 14 also includes, connected in line with the remainder, an integrator 22, a comparator 23, and an analog-to-digital converter 24 that may be part of a processing device 26 or may, as schematically illustrated, be distinct therefrom.

The tool 14 furthermore includes an on-board power source and memory 25. This may again be part of the processing device 26 but in the embodiment shown is housed in a separate, removable sub.

The analog-to-digital converter 24 preferably is such as to produce a stabilized output in the manner described herein.

The tool 14 additionally includes an optional, further sub 27 containing a gamma detector the purpose of which is to produce an indication of neutron capture cross section (sigma), based on measurements of gamma decay following each burst.

The tool 14 may be operated in accordance with the method steps described herein in order to produce porosity logs and, if the sub 27 is present, sigma logs.

The method and apparatus of the invention advantageously eliminate the need for continuous neutron sources and permit the use of low burst rate neutron generators that hitherto have not been practical propositions in the logging art.

The listing or discussion of an apparently prior-published document in this specification should not necessarily be taken as an acknowledgement that the document is part of the state of the art or is common general knowledge.

What is claimed is:

1. A method of logging a geological formation, comprising the steps of:
(i) pulsing a neutron generator so as to generate a series of neutron bursts that irradiate the formation;
(ii) without counting or detecting individual pulses stimulated by a burst from the neutron generator, operating a pair of mutually spaced radiation detectors that are located so as to detect neutrons that have traversed the formation and generate respective current outputs that are indicative of the neutron detection at the respective detectors;
(iii) integrating the current outputs of the radiation detectors to generate respective analog waveforms that are characteristic of the count rates at the detectors;
(iv) converting each of the analog waveforms to digital form;
(v) comparing the respective, resulting digital waveforms in order to establish a ratio of radiation detector count rates corresponding to the outputs of the respective radiation detectors; and
(vi) from the resulting ratio, establishing a compensated measure of a neutron-based porosity of the formation.

2. A method according to claim 1 wherein the generator is selected from the group consisting of:
a continuously operable DC neutron generator tube;
a pulsed neutron generator tube arranged to operate at a relatively high burst rate; and
a pulsed neutron generator tube arranged to operate at a relatively low burst rate.

3. A method according to claim 1 wherein each radiation detector of the pair is a neutron counter.

4. A method according to claim 3 wherein the neutron counter is a gas-filled detector.

5. A method according to claim 2 further comprising the step of periodically measuring and compensating for the effects of analog-to-digital voltage offset without interrupting pulsing of the source.

6. A method according to claim 5 wherein the step of periodically measuring and compensating takes place following each neutron burst, after the neutrons have died away, and immediately prior to the next succeeding burst.

7. A method according to claim 1 further comprising the step of operating a pair of gamma radiation detectors that measure the local neutron population in the vicinity of the detectors by measuring the gamma rays emitted as the neutrons are captured.

8. A method according to claim 1 further comprising the steps of:
operating a gamma radiation detector in order to assess the rate of radiation decay following one or more said bursts; and
determining therefrom an indication of a neutron capture cross-section of the formation.

9. A logging apparatus for logging a formation, comprising:
(i) a neutron generator that is capable of being pulsed so as to generate a series of neutron bursts that irradiate the formation;
(ii) a pair of mutually spaced radiation detectors that are located so as to detect neutrons that have traversed the formation, following irradiation of the formation by at least one said neutron burst, and generate respective current outputs that are indicative of the neutron detection at the respective detectors;
(iii) an integrator for integrating the current outputs of the radiation detectors to generate respective analog waveforms that are characteristic of the count rates at the detectors;
(iv) an analog-to-digital converter for converting each of the analog waveforms to digital form;
(v) a comparator for comparing the respective, resulting digital waveforms in order to establish a ratio of radiation detector count rates corresponding to the outputs of the respective radiation detectors; and
(vi) a processing device for establishing, from the resulting ratio, a compensated measure of a neutron-based porosity of the formation.

10. A logging apparatus according to claim 9 wherein the logging apparatus is constituted as a logging tool or part of a logging tool.

11. A logging apparatus according to claim 10 wherein the logging tool is selected from the group consisting of:
a wireline tool having a diameter of at least 2%-inches and designed to be conveyed into a borehole on wireline;
a tool having a diameter less than 2%-inches; and
a tool having an on-board power source and a memory such that the tool records data in a downhole location for subsequent downloading on recovery of the tool to a surface location.

12. A logging apparatus according to claim 9 wherein the logging apparatus is constituted as one or more subs that are assemblable together or with other subs to constitute one or more logging tools.

13. A logging apparatus according to claim 9 wherein one or more of the neutron generator, radiation detectors, integrator, analog-to-digital converter, comparator, and processing device of the apparatus is located at a location remote from a remainder of the apparatus.

14. A logging apparatus according to claim 13 wherein the processing device is located at a surface location.

15. A logging apparatus according to claim 9 wherein the neutron generator is selected from the group consisting of:
a continuously operable DC neutron generator tube;
a pulsed neutron generator tube arranged to operate at a relatively high burst rate as defined herein; and
a pulsed neutron generator tube arranged to operate at a relatively low burst rate as defined herein.

16. A logging apparatus according to claim 9 wherein each radiation detector of the pair is a neutron counter.

17. A logging apparatus according to claim 16 wherein the neutron counter is a gas-filled detector.

18. A logging apparatus according to claim 9 wherein the pair of radiation detectors includes a pair of gamma detectors.

19. A logging apparatus according to claim 9 further comprising a gamma radiation decay detector that is operable in order to assess the rate of radiation decay following one or more said bursts.

20. A logging apparatus according to claim 19 wherein the processing device is capable of determining from the output of the gamma radiation decay detector an indication of a neutron capture cross-section of the formation.

21. A logging apparatus according to claim 19 wherein the gamma radiation decay detector forms part of a sub that is releasably connectable to at least part of a remainder of the apparatus.
